(19) United States
(12) Patent Application Publication
(10) Pub. No.: US 2019/0279228 A1
(43) Pub. Date: Sep. 12, 2019

(54) SUSPICIOUS ACTIVITY REPORT SMART VALIDATION

(71) Applicant: INTERNATIONAL BUSINESS MACHINES CORPORATION, Armonk, NY (US)

(72) Inventors: Vijay Ekambaram, Chennai (IN); Ivan M. Milman, Austin, TX (US); Martin Oberhofer, Sindelfingen (DE); Sushain Pandit, Austin, TX (US)

(21) Appl. No.: 16/416,321

(22) Filed: May 20, 2019

Related U.S. Application Data
(63) Continuation of application No. 15/789,609, filed on Oct. 20, 2017.

(51) Int. Cl. G06Q 30/00; H04L 29/06; G06Q 40/02

(52) U.S. Cl. CPC G06Q 30/0185; G06Q 40/02; H04L 63/123

(57) ABSTRACT

A method, computer system, and a computer program product for smart validation of suspicious activity reports is provided. The present invention may include receiving a plurality of suspicious activity data from a reporting software. The present invention may also include analyzing the plurality of suspicious activity data using a plurality of analytics, wherein the analysis validates the plurality of stored suspicious activity data using the plurality of analytics. The present invention may then include providing feedback to a user based on the analyzed plurality of suspicious activity.

### BACKGROUND

The present invention relates generally to the field of computing, and more particularly to report validation.

Incomplete and inaccurate information disclosed on reports is a common issue. Reports filled in by hand and miscommunication between individuals managing the reports may provide faulty information on a final version of the report. Additionally, when a long time period has passed between when the report was started and before a final report is produced, an individual may have a reduced ability to easily correct portions of the report that were filled in at the beginning. A reduced ability to correct a final report for submission to a governing authority may produce ineffective reporting and ineffective results.

### SUMMARY

Embodiments of the present invention disclose a method, computer system, and a computer program product for smart validation of suspicious activity reports. The present invention may include receiving a plurality of suspicious activity data from a reporting software. The present invention may also include analyzing the received plurality of suspicious activity data using a plurality of analytics, wherein the analysis validates the received plurality of suspicious activity data using the plurality of analytics. The present invention may then include providing feedback to a user based on the analyzed plurality of suspicious activity.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for smart validation of a suspicious activity report according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for validating data in reporting software. As such, the present embodiment has the capacity to improve the technical field of data validation by cross correlating data reporting software with data saved on various databases. More specifically, various analytics may be used to detect errors in a reporting software by analyzing the report data and comparing the report data with master data, reference data or transactional data.

As previously described, incomplete and inaccurate information disclosed on reports is a common issue. Reports filled in by hand and miscommunication between individuals managing the reports may provide faulty information on a final version of the report. Additionally, when a long time period has passed between when the report was started and before a final report is produced, an individual may have a reduced ability to easily correct portions of the report that were filled in at the beginning. A reduced ability to correct a final report for submission to a governing authority may produce ineffective reporting and ineffective results.

In the realm of financial crimes and fraudulent activity, the managing environments, such as the investigation, mitigation and prosecution of fraud and financial crimes may require accurate reporting. Financial crimes and fraudulent activity may include, for example, wire fraud, money laundering, insurance fraud and transaction fraud. Therefore, it may be advantageous to, among other things, provide a counter fraud management solution by creating a smart validation process to mitigate discrepancies in reports being sent to governing bodies. The advantages of detecting errors in, for example, a suspicious activity report (SAR) or a suspicious transaction report (STR), prior to filing the SAR or the STR with the proper authorities, may avoid large fines and may avoid loss of customer reputation if a client is wrongly accused of fraudulent activity. One other advantage may include feedback providing suggestions that may better complete or provide more accuracy to the SAR or STR.

According to at least one embodiment, scoring and analytics may be used to identify the probability of fraud. Once a potential fraud is identified based on the score being above a pre-defined threshold, a case may be opened for an investigation. One possible outcome of an opened investigation may include a SAR. A SAR is a report disclosed to a governing body, such as the Financial Crimes Enforcement Network (FinCEN) in the United States. SARs may assist governing agencies in crime prevention efforts by allowing governing agencies to share SAR data for collaboration to prevent crimes. A SAR may be filed by an e-filing system and reporting software may disclose the SAR, for example, to FinCEN electronically over a communication network.

A SAR may include electronic folders with steps to be completed before being sent (i.e., electronically transmitted via a communication network) to the governing entity. Step 1 may include the filing institution contact information. Step 2 may include the filing institution where the activity occurred. Step 3 may include subject information. Step 4 may include suspicious activity information. Step 5 may include narrative where, for example, an investigator may present a case against a subject.

An example of inaccurate information, due to oversight or miscommunication during an investigation, may include an incorrect gender, occupation, phone number or social security number for the subject data inputted and stored into a SAR. A subject may be a person of interest who may be the subject to the investigation. Another example may include a person who was incorrectly added as a subject, however, the person was provably absent from the scene of the crime through video evidence or radio-frequency identification (RFID) sensor data. An example of incomplete information may include a SAR with missing subjects. Another example of incomplete information may include an individual who should have been included in the investigation who was unintentionally left out.

The present embodiment may provide smart validation of a SAR to cross-validate SAR data with various analytics and various databases prior to government filing. The smart validation program may cross-validate SAR data by leveraging a combination of analytics, such as semantic analysis, natural language processing (NLP) analysis or unstructured information management architecture (UIMA), temporal or event analysis, ontology based dependency analysis, audio analysis or video analysis.

Data analytics may include analysis of various data such as structured data, unstructured data, master data, transactional data, event data or temporal data. Data may, for example, be stored on a server database or on multiple server databases. Data may be transferred across a communication network between devices such as a server, a sensor, an internet of things (IoT) device, a camera, a microphone, a personal computer, a smart phone, a tablet or a smart watch. Structured data may include data that is highly organized, such as a spreadsheet, relational database, or data that is stored in a fixed field. Unstructured data may include data that is not organized and has an unconventional internal structure, such as a portable document format (PDF), an image, a presentation, a webpage, video content, audio content, an email, a word processing document or multimedia content.

Media analytics may include analysis of audio or video data. Audio data may include audio obtained from a microphone, such as a recorded message (e.g., a voicemail message). Another recorded message may include, for example, a phone conversation between a customer service representative and a subject, or a recorded police call (e.g., a 911 phone call) with a subject. Video data may include any video camera footage. Video camera footage may, for example, include street cameras, police officer vest or car cameras, a bank automated teller (ATM) camera or video taken from a smart phone. Media analytics may use the obtained audio file or video footage to analyze where a subject was, what occurred or what was said by the subject and incorporate the data into the verification process of the SAR.

Semantic analysis may be used to infer the complexity of interactions, such as the meaning and intent of the language, both verbal and non-verbal (e.g., spoken word captured by a microphone and processed for meaning and intent or type written words captured on a word processing document or on a social media account). Semantic analysis may consider current and historical activities of a subject to determine if the data incorporated in the SAR is accurate compared to data found from many different sources (e.g., various server databases). An example of a server database may include a corporation's client database, a public government entity database (e.g., a business name search on a government website), a bank's client database or a social media database that stores social media posts.

NLP may also use both structured data and unstructured data to extract meaningful information to compare with the data in a reporting software (e.g., SAR). NLP may compare stored data on a database with, for example, SAR data stored on a computer hard drive, to seek inconsistencies before filing the SAR with a government entity. UIMA may provide software architecture to run one or more analytic models using unstructured data.

Fraud management software may use a score or a threshold to identify potential fraudulent activity. Once a potential fraudulent activity has been identified, the smart validation program may run various analyses that may compare data in a reporting software with different sources to cross-reference and validate the data before submitting the report. The present embodiment may weigh semantic analysis, NLP analysis, temporal or event analysis and the ontology based dependency analysis heavier than the audio or video analysis. The heavier weight given to a particular analysis may take precedence over the result of a lower weighted analysis. In other embodiments, the weight of each type of analysis may be adjusted to take different precedencies. Alternatively, one other embodiment may weigh each analysis equally (e.g., if each analysis is weighed as 1, then all approaches used are weighted equally and no precedence is used).

The present embodiment may incorporate various analytic analyses. One embodiment may, for example, cross-correlate subject information provided in a SAR with master data, reference data and transactional data. The SAR fields may also be analyzed against ontologies to detect potential mutual dependencies for inclusion or exclusion. An ontology may be used to connect or map relationships within an entity to verify data. An ontology may include, for example, a web services platform or a software platform that may analyze data semantically based on input data types, output data types and data hierarchies. An example of a semantic analyzer may include web ontology language (OWL) or Protégé.

The narrative text portion of the SAR may be analyzed to compare with SAR fields to detect potential inconsistencies. For example, the investigator checks a box in a SAR field that indicates the subject is male but the narrative uses the word she to describe the subject. Temporal events may also be analyzed for inconsistencies. A temporal event may, for example, be analyzed by extracting dates written in the narrative portion of the SAR and correlating the dates to the person or subject in the SAR to estimate if the data is accurate (e.g., the subject was the person extracting money from the ATM from bank branch A at a particular time). Video and audio analytics may be used for facial detection and validation or a named entity detection or validation. Video analytics may include, for example, using video captured at a bank ATM to identify a person who used the ATM based on facial recognition software. Audio analytics may include, for example, a recorded phone conversation between a bank's employee and a bank client during a customer service call and using voice recognition software to analyze the client's voice and to identify the client.

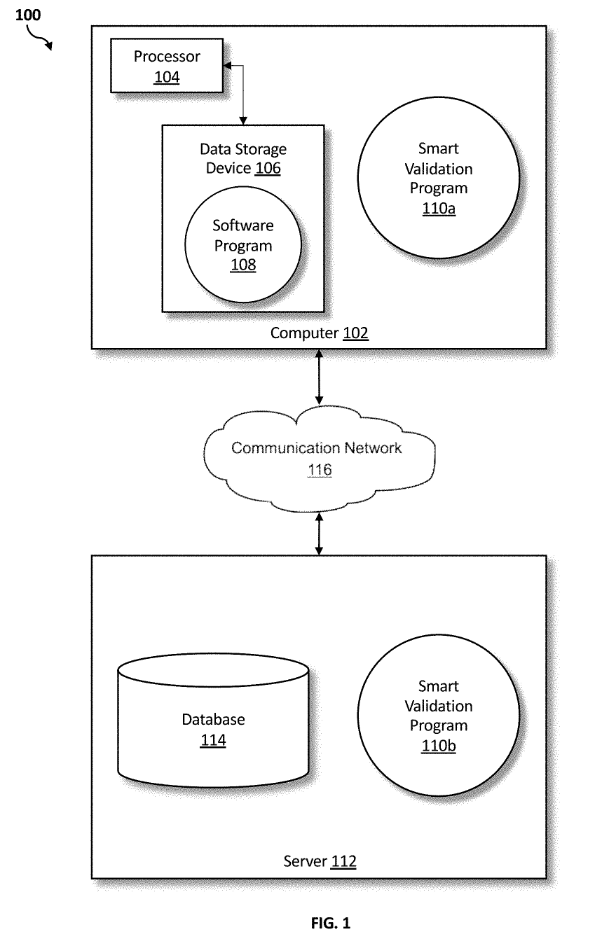

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a smart validation program 110a. The networked computer environment 100 may also include a server 112 that is enabled to run a smart validation program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

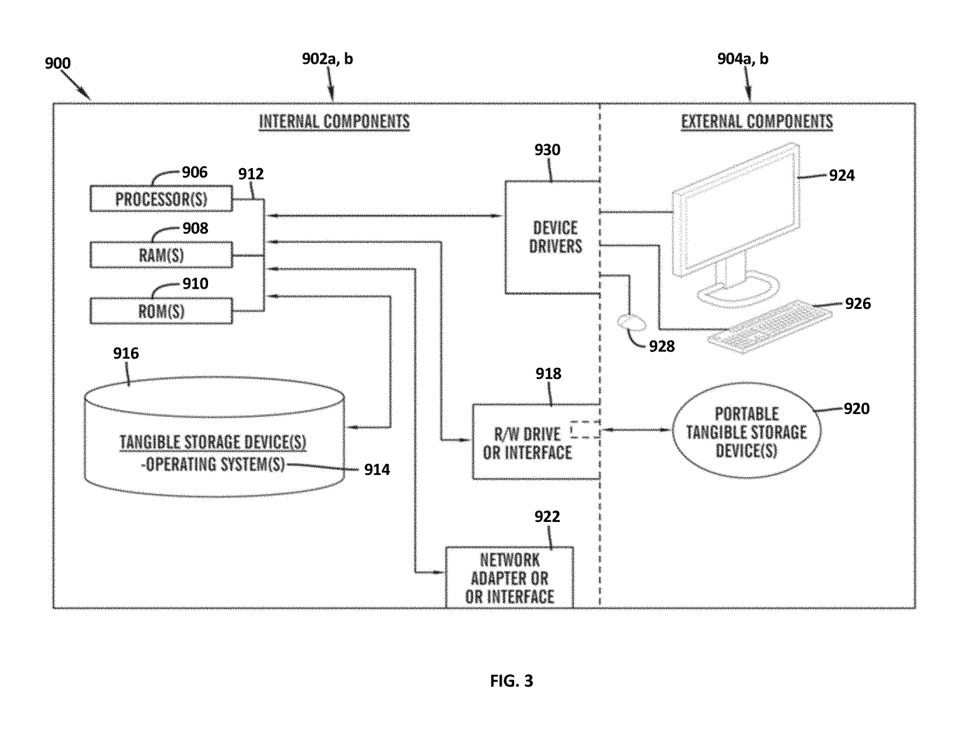

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the smart validation program 110a, 110b may interact with a database 114 that may be embedded in various storage devices, such as, but not limited to a computer/mobile device 102, a networked server 112, or a cloud storage service.

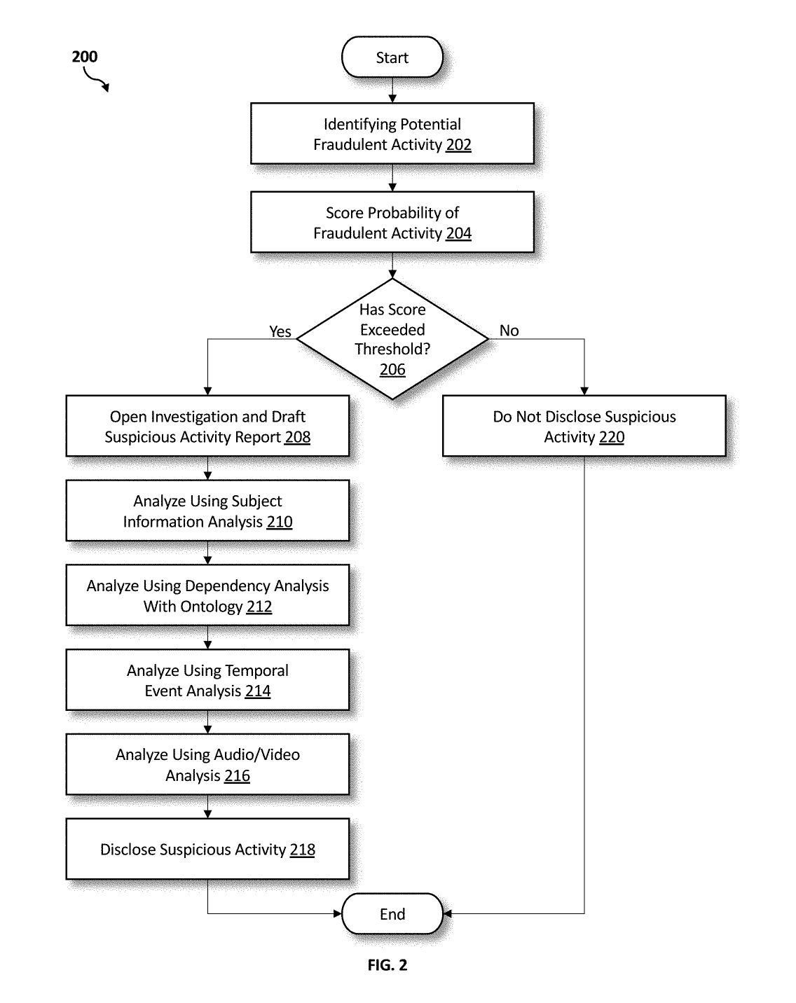

According to the present embodiment, a user using a client computer 102 or a server computer 112 may use the smart validation program 110a, 110b (respectively) to cross-correlate and validate subject information provided in a SAR with outside data sources (e.g., master data, reference data and transactional data). The smart report validation method is explained in more detail below with respect to FIG. 2.

Referring now to FIG. 2, an operational flowchart illustrating the exemplary smart validation of a suspicious activity report process 200 used by the smart validation program 110a, 110b according to at least one embodiment is depicted.

At 202, a potential fraudulent activity is identified. Fraud detection software may analyze human behavior such that deviations associated with normal human behavior may provide discrepancies by evaluating parameters. An example of fraud detection software may include IBM® Counter Fraud Management (IBM Counter Fraud Management and all IBM Counter Fraud Management-based trademarks and logos are trademarks or registered trademarks of International Business Machines Corporation and/or its affiliates). A person's actions may be analyzed to determine if fraudulent activity is likely. For example, a bank's client withdraws multiple large cash withdrawals in one day at 3 different ATM machines in 3 different locations and this behavior is not normal for the bank's client. Upon analysis, since this activity is not a normal course of action for the bank's client, the activity may be identified as potentially fraudulent.

Then, at 204, the probability of fraudulent activity is scored. A profile analysis of human behavior and discrepancies associated with the person may produce a score associated with acceptable behavior. Behavior may be scored within the scope of a particular business or a particular crime. The higher the discrepancy found, the higher the suspicion that a fraudulent activity has occurred. Behavior may be analyzed, for example, by actions taken by a bank client that is out of the particular client's ordinary behavior or actions that are not ordinary for the general public that relate to banking transactions. The analysis may be processed using IBM® Counter Fraud Management.

Next, at 206, the smart validation program 110a, 110b determines if the score has exceeded a pre-determined threshold. The score provided by fraud detection software may be used to determine if fraudulent activity has occurred. A score that exceeds the pre-defined threshold of the fraud detection software may indicate that suspicious activity is likely or a crime has taken place. A predefined threshold may be set and if the score exceeds the threshold, then the fraud detection software may provide feedback to the user that the analyzed activity has a high likelihood of fraud.

If the smart validation program 110a, 110b determines that the score has exceeded the pre-determined threshold at 206, then an investigation is opened and a suspicious activity report is drafted at 208. An investigation may be opened and supervised by an individual, a company, an entity or a government. An investigation may follow a procedure of gathering documents, data, social media data, financial information or any other information necessary or obtainable to the individual supervising the investigation. A SAR may be completed during the investigation period. Continuing from the previous example, the bank's client has engaged in activity that is consistent with fraudulent activity and an investigation has been opened to document the suspicious activity. The SAR is completed by the lead investigator and the subject is the bank's client.

At 210, the suspicious activity report is analyzed using subject information analysis. The smart validation program 110a, 110b may analyze various sections of the SAR using various analytics that may include semantic analysis, natural language processing (NLP) analysis, temporal or event analysis, ontology based dependency analysis, audio analysis or video. Subject information analysis may use SAR subject information data to be analyzed against data stored on one or more databases (e.g., database 114). A weighted algorithm may be used consisting of one or more analyses (e.g., subject matter analysis, dependency analysis using ontology, a temporal event analysis and an audio or video analysis). The weight may be set to give different analyses higher or lower importance or alter the hierarchy of the inconsistencies found by the smart validation program 110a, 110b. For example, the subject information analysis is weighted heavier than the audio analysis and inconsistencies are found, however, the inconsistencies contradict one another. The subject information analysis finds that the subject is a female and the audio analysis results contradict the subject information analysis, therefore, the subject information analysis result will be used. The order of analyses may be altered and one or more analysis may be used when validating the SAR.

For structured fields in the SAR, the smart validation program 110a, 110b may implement subject information analysis by extracting the fields related to the name (e.g., name of person, subject or organization), address, contact method, personal details (e.g., gender, date of birth, organization details such as a corporate tax identification number). Then services may be considered, processed or performed by the smart validation program 110a, 110b and cross referenced with the extracted SAR fields. One service may include a data quality service, which may inspect the format of the field, for example, such that the value in an email field contains an @ symbol and a period. One other service that may be performed includes a data standardization service to verify, for example, name and address verification. One service may include IBM® InfoSphere® Information Server (IBM InfoSphere Information Server and all IBM InfoSphere Information Server-based trademarks and logos are trademarks or registered trademarks of International Business Machines Corporation and/or its affiliates).

One other service may include a data verification service to verify if a given address exists in a directory (e.g., United States Postal Service directory). An example of a data verification service may include a service obtained from an information server (e.g., IBM® InfoSphere® Information Server), a data processing servicer (e.g., InfoCanada™ (InfoCanada and all InfoCanada-based trademarks and logos are trademarks or registered trademarks of InfoGroup Incorporated and/or its affiliates)), or a telecommunication company. One other service may include a matching service to identify a customer record in a master data management (MDM) system and compare data of the populated SAR fields with the details in the MDM system to verify if the content of the populated SAR data fields is accurate. An example of a MDM system is IBM® InfoSphere® Master Data Management Reference Data Management Hub (IBM InfoSphere Master Data Management Reference Data Management Hub and all IBM InfoSphere Master Data Management Reference Data Management Hub-based trademarks and logos are trademarks or registered trademarks of International Business Machines Corporation and/or its affiliates). The MDM system may also be used to compare party contract roles (e.g., guarantor, beneficiary, payee or owner) and compare the roles with the corresponding extracted SAR report fields (e.g., from SAR section/step 3).

One other service that may be performed by the smart validation program 110a, 110b is a hidden relationship service to discover relationships that may be unknown or not obvious between individuals, individuals and organizations, and organizations. For example, data extracted from SAR section/step 3 may be compared to the data provided by IBM® InfoSphere® Identity Insight (IBM InfoSphere Identity Insight and all IBM InfoSphere Identity Insight-based trademarks and logos are trademarks or registered trademarks of International Business Machines Corporation and/or its affiliates).

At 212, the suspicious activity report is analyzed using dependency analysis with ontology. The smart validation program 110a, 110b may analyze the data in the SAR entries to determine which ontology may be used. Using, for example, an ontology for the finance industry, including financial crimes, a SAR data field relating to a financial crime may be compared to the ontology if the particular crime has necessary pre-conditions that are not mentioned in the SAR. Additionally, if the listed crime types are mutually exclusive, then they may not appear in the same SAR. For example, the ontology is loaded in Protégé OWL, an open-source ontology editor, to initiate the SAR data as an assertion against the ontology graph, then the reasoner in Protégé OWL is run to detect inconsistencies.

At 214, the suspicious activity report is analyzed using temporal event analysis. Temporal event analysis may use NLP or UIMA based text analytics to extract data from text written in, for example, the narrative portion of the SAR. The narrative portion of the SAR may be analyzed by NLP or UIMA to extract, for example, names or entities, dates, transactions, transaction sizes (i.e., currency amount of the financial transaction), locations and relationships between names or entities.

A sample section of the SAR may, for example, be typed into the narrative portion of the SAR, by an investigator, and include the following information: “John Doe withdrew $10,000 on Mar. 20, 2014. The next day, Mar. 21, 2014, he withdrew another $8,000 and on that same day, Mar. 21, 2014, another $9,000 was withdrawn at a different bank branch. Two of the three withdrawals were made at 1111 E. Anytown Branch, with the last withdrawal for $9,000 made at another branch. While the customer has a lot of money in his account (account # 123456789), these withdrawals do not seem typical.” From this narrative, if the subject, John Doe, was not near the bank branch address on Mar. 20, 2014 and Mar. 21, 2014, then there may be a strong indication that an oversight has been made on the SAR by adding John Doe as a subject. In addition to faulty SAR data impeding crime prevention, failure to correctly file a SAR, for financial institutions, may result in large fines.

The smart validation program 110a, 110b may use documents obtained by the MDM (e.g., driver's license or passport) to capture the identity of the subject or individual. If the crime is insider fraud, the MDM may provide documents obtained during the employment process with an entity. Other MDM documents that may validate identity may have been provided through a financial agreement or sales process made by the subject. Once the MDM documents have been obtained, facial recognition software may be used to identify the subject or individual named in the narrative portion of the SAR. The facial recognition software may analyze the photographs obtained as a result of the MDM document search (e.g., a photograph obtained on a driver's license or a passport).

One other method for obtaining a person's identity may include surveillance infrastructures, such as video capture at an ATM machine or video captured at a place of business. The video captures may provide the necessary facial features to identify which person, for example, used the ATM machine or which person visited the local bank. The video capture may also provide the date and time the person used the ATM machine or visited the bank. Facial recognition software may be used to identify the person's identity captured by surveillance video or photograph. The identified surveilled person data may be compared to the results (e.g., identity, name, date, location) produced by the MDM documents. If, in the narrative portion of the SAR, the indicated date and the claimed person does not align with the person identified through face recognition and the MDM data, an error may have been made in the SAR.

At 216, the suspicious activity report is analyzed using audio or video analysis. Audio or video analysis may be used to detect and validate a person or an entity. Audio or video may be captured, for example, by a camera or a microphone and saved to a database accessible by a computer 102. The camera or microphone may be placed in public settings, for example, at a local bank, a gas station, or to capture bank representative telephone interactions with clients. The data obtained by the camera or microphone may capture fraudulent activity. Video analysis and audio analysis may be used to extract key information from different types of video files (e.g., wmv, mp4, or fly), audio files (e.g., way or mp3) or different types of cameras. Video analysis may allow a user to use advanced search capabilities to extract data relating to relevant images. One example of video analytics the smart validation program 110a, 110b may use is IBM® Intelligent Video Analytics (IBM Intelligent Video Analytics and all IBM Intelligent Video Analytics-based trademarks and logos are trademarks or registered trademarks of International Business Machines Corporation and/or its affiliates).

One other embodiment for analyzing facial features to validate identity may include a secondary facial matching procedure used to establish if the subject captured in the SAR is the correct subject. Secondary facial matches may be done using facial pattern detection or matching technology, such as an indicator of compromise (IOC) facial recognition engine. IOC facial recognition engines may be used by services and software such as IBM® i2® COPLINK® Face Match (IBM i2 COPLINK Face Match and all IBM i2 COPLINK Face Match-based trademarks and logos are trademarks or registered trademarks of International Business Machines Corporation and/or its affiliates).

Then at 218, the suspicious activity is disclosed. The smart validation program 110a, 110b may perform one service or analysis or more than one service or analysis to check for inconsistencies between the extracted SAR data and the service performed or analytics used. Feedback may be provided to the user, for example, as a notification to the user operating a computer 102 or a smart phone (e.g., an email notification or an alert that pops up onto a screen or monitor), to correct the inconsistencies discovered prior to submission of the SAR.

If the smart validation program 110a, 110b determined that the score has not exceeded the pre-determined threshold at 206, then the suspicious activity is not disclosed at 220. No suspicious activity would indicate that a SAR may not need to be drafted or filed.

It may be appreciated that FIG. 2 provides only an illustration of one embodiment and does not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 3. Each of the sets of internal components 902 a, b includes one or more processors 906, one or more computer-readable RAMs 908, and one or more computer-readable ROMs 910 on one or more buses 912, and one or more operating systems 914 and one or more computer-readable tangible storage devices 916. The one or more operating systems 914, the software program 108 and the smart validation program 110a in client computer 102, and the smart validation program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the smart validation program 110a, 110b can be stored on one or more of the respective portable computer-readable tangible storage devices 920, read via the respective R/W drive or interface 918, and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the smart validation program 110a in client computer 102 and the smart validation program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the smart validation program 110a in client computer 102 and the smart validation program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926, and computer mouse 928. The device drivers 930, R/W drive or interface 918, and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

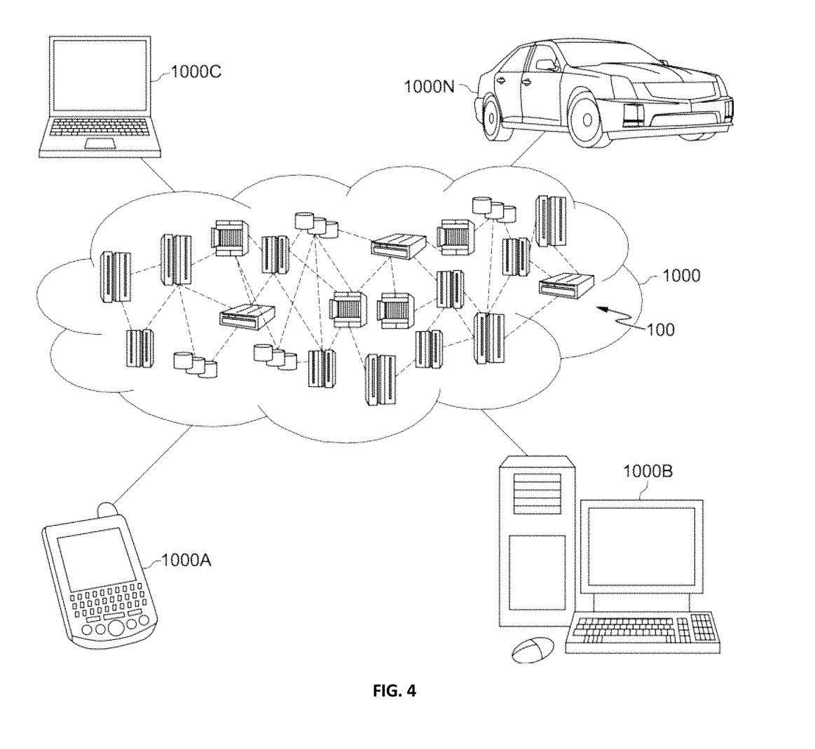

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

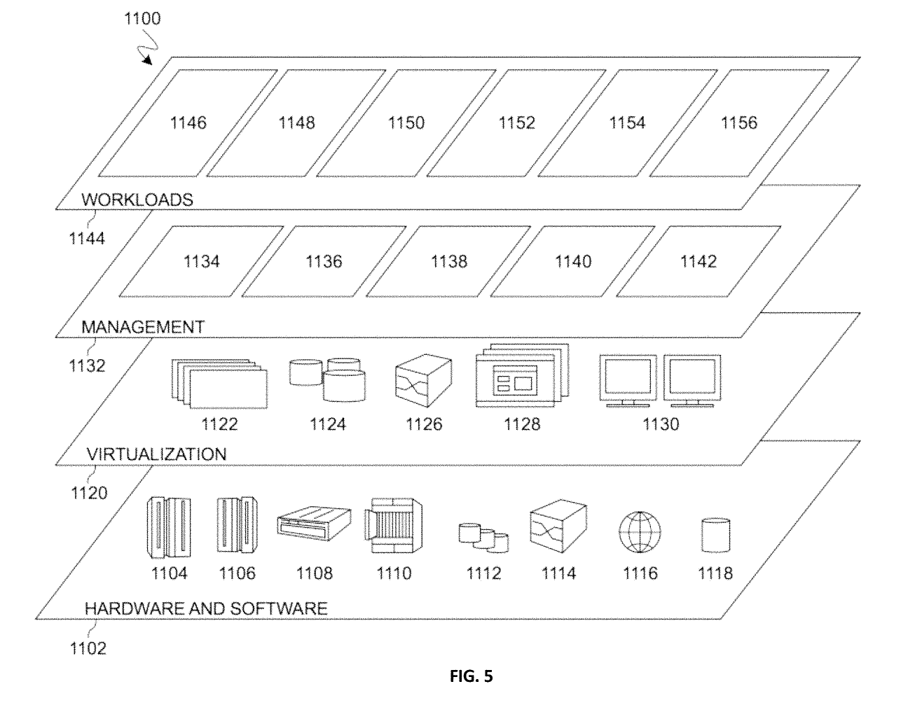

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and smart validation 1156. A smart validation program 110a, 110b provides a way to validate data in reporting software.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for validating data, the method comprising:
receiving a plurality of suspicious activity data from a reporting software;
analyzing the received plurality of suspicious activity data using a plurality of analytics, wherein the analysis validates the received plurality of suspicious activity data using the plurality of analytics; and
providing feedback to a user based on the analyzed plurality of suspicious activity.

2. The method of claim 1, wherein the plurality of analytics is selected from a group consisting of subject information analysis, dependency analysis using ontology, temporal event analysis, audio analysis, video analysis, semantic analysis, natural language processing (NLP) analysis and unstructured information management architecture (UIMA).

3. The method of claim 1, wherein the reporting software is used to disclose a suspicious activity report (SAR) to a governing authority.

4. The method of claim 1, wherein the reporting software data is cross-correlated against the results of the plurality of analytics to find at least one error in the reporting software before a report is submitted to a governing authority.

5. The method of claim 1, wherein the plurality of suspicious activity data may be populated by an investigator, wherein the investigator gathers a plurality of pertinent data to report.

6. The method of claim 1, wherein the feedback provided to the user is an alert on a computing device, wherein the feedback provides at least one error on a suspicious activity report (SAR) field to the user, wherein the user corrects the provided at least one error, and wherein the user discloses the suspicious activity to a governing authority.

7. The method of claim 1, wherein the plurality of suspicious activity data relates to a financial crime.

8. A computer system for validating data, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving a plurality of suspicious activity data from a reporting software;
analyzing the received plurality of suspicious activity data using a plurality of analytics, wherein the analysis validates the received plurality of suspicious activity data using the plurality of analytics; and
providing feedback to a user based on the analyzed plurality of suspicious activity.

9. The computer system of claim 8, wherein the plurality of analytics is selected from a group consisting of subject information analysis, dependency analysis using ontology, temporal event analysis, audio analysis, video analysis, semantic analysis, natural language processing (NLP) analysis and unstructured information management architecture (UIMA).

10. The computer system of claim 8, wherein the reporting software is used to disclose a suspicious activity report (SAR) to a governing authority.

11. The computer system of claim 8, wherein the reporting software data is cross-correlated against the results of the plurality of analytics to find at least one error in the reporting software before a report is submitted to a governing authority.

12. The computer system of claim 8, wherein the plurality of suspicious activity data may be populated by an investigator, wherein the investigator gathers a plurality of pertinent data to report.

13. The computer system of claim 8, wherein the feedback provided to the user is an alert on a computing device, wherein the feedback provides at least one error on a suspicious activity report (SAR) field to the user, wherein the user corrects the provided at least one error, and wherein the user discloses the suspicious activity to a governing authority.

14. The computer system of claim 8, wherein the plurality of suspicious activity data relates to a financial crime.
